(19) United States
(12) Patent Application Publication
(10) Pub. No.: US 2024/0319755 A1
(43) Pub. Date: Sep. 26, 2024

(54) LOW QUIESCENT CURRENT AND FAST TRANSIENT VOLTAGE REGULATOR WITH TRANSCONDUCTANCE BOOSTER

(71) Applicant: QUALCOMM Incorporated, San Diego, CA (US)

(72) Inventors: Jize JIANG, Singapore (SG); Hua GUAN, San Diego, CA (US)

(21) Appl. No.: 18/188,891

(22) Filed: Mar. 23, 2023

(51) Int. Cl. G05F 1/575

(52) U.S. Cl. CPC G05F 1/575

(57) ABSTRACT

Apparatus and methods for voltage regulation. One example circuit generally includes a first transistor having a source coupled to a Vin node and having a drain coupled to a Vout node; a second transistor having a drain coupled to a gate of the first transistor; a third transistor having a drain coupled to a source of the second transistor and having a source coupled to a reference potential node of the power supply circuit; a first amplifier having a first input coupled to a reference voltage node and having an output coupled to a gate of the third transistor, with feedback between the Vout node and a second input of the first amplifier; and a second amplifier having a first input coupled to a bias node, having a second input coupled to the source of the second transistor, and having an output coupled to a gate of the second transistor.

### TECHNICAL FIELD

Certain aspects of the present disclosure generally relate to electronic circuits and, more particularly, to a power supply circuit and techniques for voltage regulation.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator may be implemented by a switched-mode power supply (SMPS), such as a buck converter, a boost converter, or a buck-boost converter.

Power management integrated circuits (power management ICs or PMICs) are used for managing the power requirement of a host system and may include and/or control one or more voltage regulators (e.g., boost converters). A PMIC may be used in battery-operated devices, such as mobile phones, tablets, laptops, wearables, etc., to control the flow and direction of electrical power in the devices. The PMIC may perform a variety of functions for the device such as DC-to-DC conversion, voltage regulation, battery charging, power-source selection, voltage scaling, power sequencing, etc. For example, a PMIC may feature an LDO regulator for voltage regulation.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed to a power supply circuit. The power supply circuit generally includes: a first transistor having a source coupled to an input voltage (Vin) node and having a drain coupled to an output voltage (Vout) node; a second transistor having a drain coupled to a gate of the first transistor; a third transistor having a drain coupled to a source of the second transistor and having a source coupled to a reference potential node of the power supply circuit; a first amplifier having a first input coupled to a reference voltage node and having an output coupled to a gate of the third transistor, wherein a feedback path is coupled between the Vout node and a second input of the first amplifier; and a second amplifier having a first input coupled to a bias node, having a second input coupled to the source of the second transistor, and having an output coupled to a gate of the second transistor.

Certain aspects of the present disclosure are directed to a wireless device including the power supply circuit described herein.

Certain aspects of the present disclosure provide a wearable device including the power supply circuit described herein.

Certain aspects of the present disclosure are directed to an Internet of Things (IoT) device including the power supply circuit described herein.

Certain aspects of the present disclosure are directed to an integrated circuit (IC) including the power supply circuit (or at least a portion of the power supply circuit) described herein.

Certain aspects of the present disclosure are directed to an amplifier circuit. The amplifier circuit generally includes an input stage and an output stage having an input coupled to an output of the input stage. The output stage includes a transistor and an amplifier. The amplifier has a first input coupled to a bias node, has a second input coupled to a source of the transistor, and has an output coupled to a gate of the transistor, the amplifier being configured to effectively boost a transconductance of the transistor.

Certain aspects of the present disclosure are directed to a method of amplification. The method generally includes driving a gate of a first transistor in an output stage of an amplifier circuit with a first amplifier and biasing a gate of a second transistor in the output stage of the amplifier circuit with a second amplifier receiving feedback from a source of the second transistor, the second transistor being coupled in cascode with the first transistor.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a voltage regulator, in which aspects of the present disclosure may be implemented.

FIG. 2 is a circuit diagram of an example low-dropout (LDO) regulator, in which aspects of the present disclosure may be implemented.

FIG. 3A is a circuit diagram of an example low quiescent current (I_{Q}) LDO regulator, in which aspects of the present disclosure may be implemented.

FIG. 3B is a circuit diagram of an example low I_{Q} LDO regulator implemented with a transconductance-booster circuit, in accordance with certain aspects of the present disclosure.

FIG. 4 is a flow diagram illustrating example operations for amplification and/or voltage regulation, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Low quiescent current (I_{Q}) and fast transient operation are important performance metrics for voltage regulators (e.g., low-dropout (LDO) regulators) in various applications, such as portable, battery-operated devices. Low I_{Q} and fast transient operation are particularly important for wearable devices and Internet of Things (IoT) devices, where battery life is of great concern. However, it is challenging to achieve both low I_{Q} and fast transient operation in a single regulator circuit, for reasons presented below.

In view of these factors, certain aspects of the present disclosure provide methods and apparatus for supplying power using a linear voltage regulator (e.g., an LDO regulator) with a low I_{Q} error amplifier circuit. The voltage regulator may be capable of fast transient operation while maintaining low I_{Q} (e.g., sub-μA I_{Q}). To accomplish this, one example voltage regulator may include a multi-stage error amplifier having an output stage with cascoded transistors, Miller compensation, and a transconductance (gₘ)-booster circuit (with an amplifier and a local feedback loop) for increasing the effective gₘ of one of the cascoded transistors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

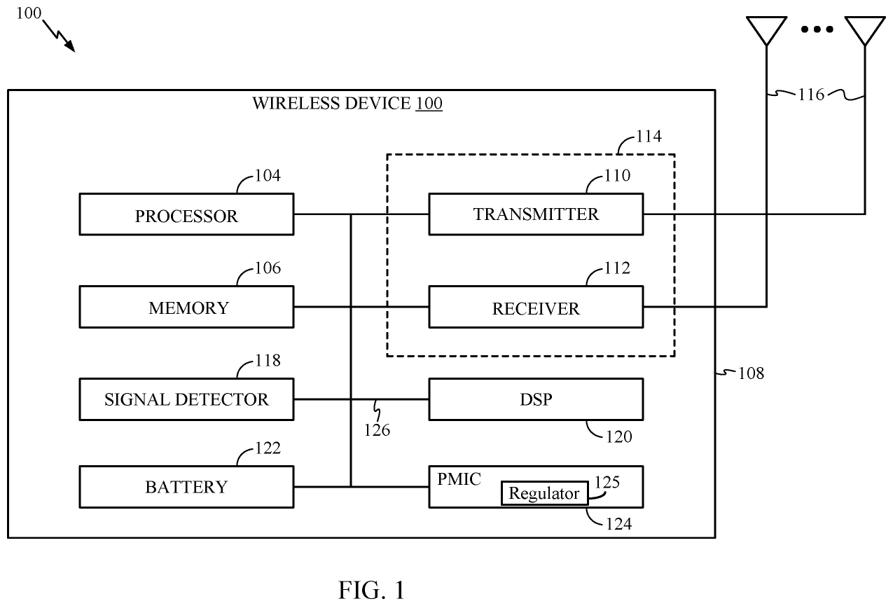

FIG. 1 illustrates a device 100. The device 100 may be a battery-operated device such as a cellular phone, a personal digital assistant (PDA), a handheld device, a wireless modem, a smartphone, a tablet, a laptop computer, a personal computer, a wearable device, an Internet of Things (IoT) device, etc. The device 100 is an example of a device that may be configured to implement the various systems and methods described herein.

The device 100 may include a processor 104 which controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a housing 108 that may include a transmitter 110 and a receiver 112 to allow transmission and reception of data between the device 100 and a remote location. The transmitter 110 and receiver 112 may be combined into a transceiver 114. A plurality of antennas 116 may be attached to the housing 108 and electrically coupled to the transceiver 114. The device 100 may also include (not shown) multiple transmitters, multiple receivers, and multiple transceivers.

The device 100 may also include a signal detector 118 that may be used in an effort to detect and quantify the level of signals received by the transceiver 114. The signal detector 118 may detect such signals as total energy, energy per subcarrier per symbol, power spectral density and other signals. The device 100 may also include a digital signal processor (DSP) 120 for use in processing signals.

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC-to-DC conversion, voltage regulation (e.g., with voltage regulator 125) battery charging, power-source selection, voltage scaling, power sequencing, etc. In certain aspects, the voltage regulator 125 may be a low-dropout (LDO) regulator implemented using an error amplifier with a transconductance (gₘ)-booster circuit, as described herein.

The various components of the device 100 may be coupled together by a bus system 126, which may include a power bus, a control signal bus, and a status signal bus in addition to a data bus.

### Example Voltage Regulation System

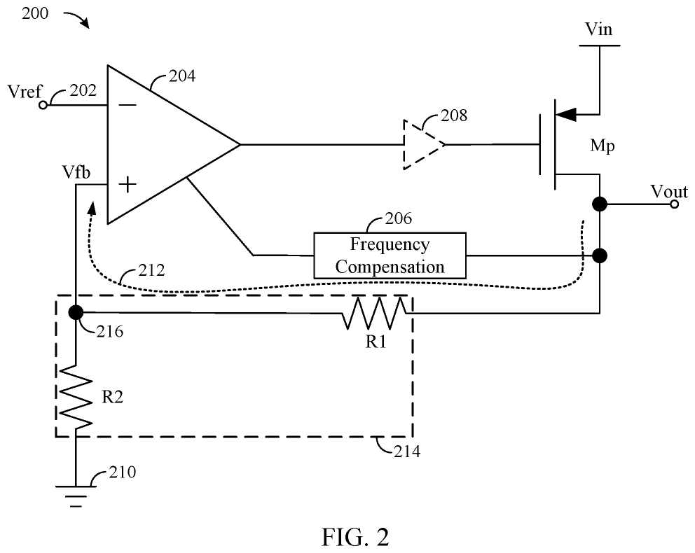

FIG. 2 is a circuit diagram of an example low-dropout (LDO) regulator 200, in which aspects of the present disclosure may be implemented. The LDO regulator 200 may include an amplifier 204 (e.g., an error amplifier (EA)) having an output coupled to a gate of a transistor Mp (e.g., a power field-effect transistor (FET), which may be a p-type transistor (as shown) or an n-type transistor). Also referred to as the “pass transistor,” the transistor Mp may have a source coupled to an input voltage (Vin) node and a drain coupled to an output voltage (Vout) node. The LDO regulator 200 may also include a feedback path 212 coupled between the Vout node and a positive input of the amplifier 204. The feedback path 212 may include a voltage divider 214 (e.g., resistive elements R1, R2) coupled between the Vout node and a reference potential node 210, where a tap 216 of the voltage divider is coupled to the positive input of the amplifier 204 to provide a feedback voltage (Vfb) to the amplifier.

The LDO regulator 200 may also include frequency compensation circuitry 206, which may be coupled between the Vout node and internal components of the amplifier 204. The frequency compensation circuitry 206 may be used to provide Miller compensation (also referred to as “feedforward compensation”), for example.

The negative input of the amplifier 204 may be coupled to a reference voltage node 202 configured to have a reference voltage (Vref), which is ideally provided by a stable reference source. During operation of the LDO regulator 200, the error amplifier drives the transistor Mp to keep Vfb equivalent to Vref. In this manner, the output voltage of the LDO regulator 200 at the Vout node is regulated, despite fluctuations in the input voltage at the Vin node. The Vout node may act as a power supply rail with a regulated voltage for one or more other circuits (not shown).

In some cases, the LDO regulator 200 may also include an optional buffer 208 coupled between the output of the amplifier 204 and the gate of the transistor Mp. The buffer 208 is configured to drive the relatively large gate capacitance (e.g., the gate-to-drain capacitance (Cgd) and the gate-to-source capacitance (Cgs)) of the power transistor (transistor Mp), based on an output of the amplifier 204, thereby enhancing transient performance of the LDO regulator. In other words, the amplifier 204 drives the buffer 208, which in turn, drives the gate (and the gate capacitance) of transistor Mp, to keep Vfb equal to Vref.

To achieve fast transient operation for the LDO regulator, the buffer 208 typically reserves a large current. When a load transient occurs at the Vout node, the buffer's reserved current can be used to quickly charge or discharge the gate capacitance of the transistor Mp. However, this faster transient performance comes at a price, since the buffer 208 draws a relatively large quiescent current (I_{Q}), which may prohibit use of such a power-hungry buffer in a low I_{Q} LDO regulator design.

### Example Low I_{Q} Voltage Regulator

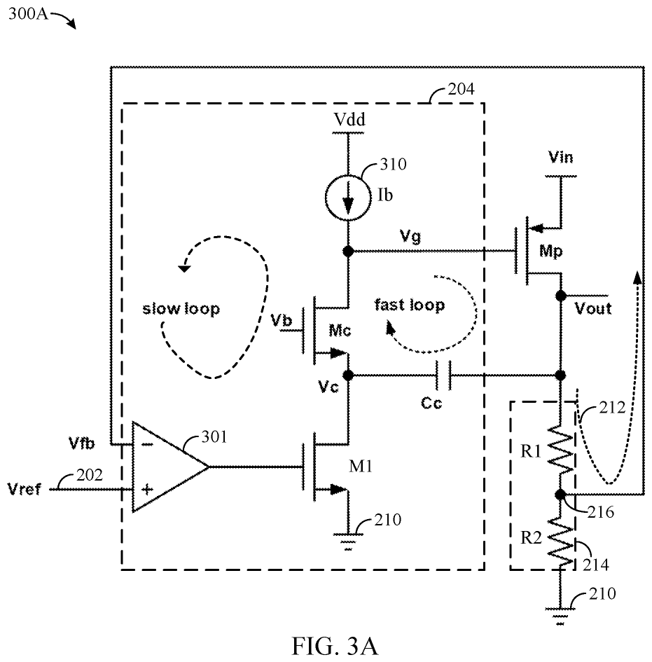

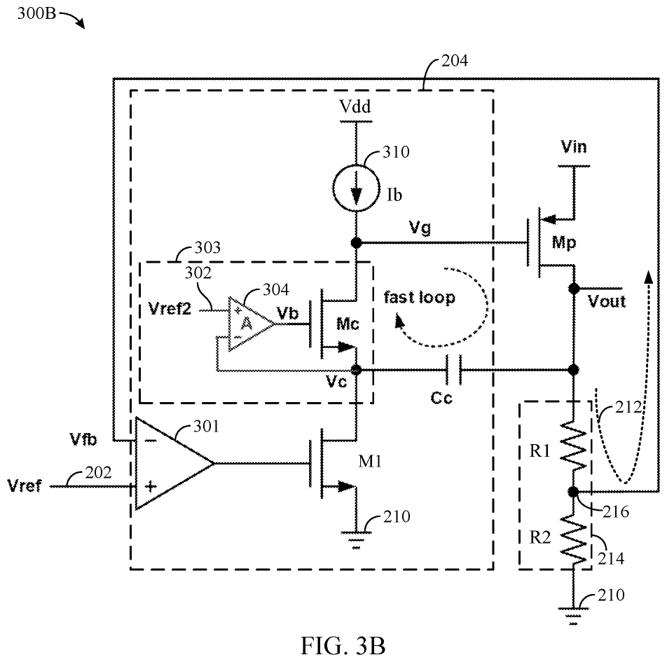

FIG. 3A is a circuit diagram of an example low quiescent current (I_{Q}) LDO regulator (e.g., LDO regulator 300A), in which aspects of the present disclosure may be implemented. In the LDO regulator 300A, the amplifier 204 may be implemented as a two-stage amplifier, having an input stage (also referred to as a “transconductance stage”) and an output stage. The input stage may be represented by an amplifier 301, which may include a differential pair of input transistors (not shown), which may be coupled to an active load (not shown) and to the output stage. The output stage may include a transistor M1, a transistor Mc, and a current source 310. The transistors M1 and Mc may be implemented as cascoded transistors, which may be p-type transistors or n-type transistors (as shown). The topology for this output stage provides low I_{Q} for the LDO regulator 300A. For certain aspects, the frequency compensation circuitry 206 may be implemented by a frequency compensation capacitive element Cc, as illustrated, to provide Miller compensation, for example, for a more stable LDO regulator.

The amplifier 301 may have a positive input coupled to the reference voltage node 202 and a negative input coupled to the feedback path 212. The amplifier 301 may also have an output coupled to a gate of transistor M1. A source of transistor M1 may be coupled to the reference potential node 210, and a drain of transistor M1 may be coupled to a source of transistor Mc and the frequency compensation capacitive element Cc at a cascode voltage (Vc) node. A drain of transistor Mc may be coupled to the current source 310 and a gate of transistor Mp via a gate voltage (Vg) node. A gate of transistor Mc may be coupled to a bias voltage (Vb) node. The current source 310 may be coupled to a power supply rail (labeled “Vdd”). In certain aspects, the voltage at the Vdd node may be the same as the voltage at the Vin node.

Multiple operational loops may be designed in the LDO regulator 300A. A first loop may be formed by the amplifier 204 driving the transistor Mp and the voltage divider 214 providing the voltage feedback (Vfb) (via feedback path 212) for comparison with Vref at the amplifier 204. The first loop may be a relatively slow loop that effectively provides direct-current (DC) regulation for the LDO regulator 300A. A second loop may be formed by a path from the Vout node through the frequency compensation capacitive element Cc, through transistor Mc, and back to transistor Mp. The second loop may be a relatively fast loop for transient performance.

With the fast loop, a load transient at the Vout node may be handled by the frequency compensation capacitive element Cc. For example, when a load attack happens, the output voltage at the Vout node may dip. As a result of the coupling between the Vout node and the Vc node (through the frequency compensation capacitive element Cc), the Vc node may also dip. The variation in the Vc node creates an alternating current (AC) current through transistor Mc. The AC current is equal to the transconductance (gₘ) of transistor Mc multiplied by the voltage variation on the Vc node. A larger gₘ of transistor Mc leads to a higher AC current. The AC current discharges the Vg node, which causes transistor Mp to turn on more strongly, generating temporarily increased drain-to-source current (I_{DS}) through transistor Mp to compensate for the load transient at the Vout node. The rate of discharge of the gate capacitance of transistor Mp is related to the amount of created AC current (e.g., when the created AC current is higher, the gate capacitance of transistor Mp discharges faster, resulting in a faster transient response of the Vout node). Thus, a larger gₘ of transistor Mc leads to a faster transient response for the LDO regulator.

However, to achieve low I_{Q} for the LDO regulator 300A, cascode transistor Mc may be a relatively small transistor, especially compared to the size of the power transistor Mp. This small transistor Mc may have limited transconductance, thereby limiting the transient performance. This has led to a tradeoff in LDO regulators between low I_{Q} and fast transient response.

### Example Low I_{Q} and Fast Transient Voltage Regulator with Transconductance Booster

To overcome this tradeoff, certain aspects of the present disclosure provide an LDO regulator implementation capable of fast transient operation while maintaining low I_{Q} (e.g., I_{Q}<μA) using a transconductance (gₘ) booster.

FIG. 3B is a circuit diagram of an example LDO regulator 300B implemented with a gₘ-booster circuit 303 to boost the transconductance of the cascode transistor Mc, without increasing the I_{Q} of the output stage, in accordance with certain aspects of the present disclosure. The LDO regulator 300B may be similar to the LDO regulator 300A, but with the addition of an amplifier 304, plus associated circuitry and connections. The gₘ-booster circuit 303 includes the amplifier 304 and transistor Mc. As illustrated in FIG. 3B, a positive input of the amplifier 304 may be coupled to a bias voltage node 302, which may be provided with a constant bias voltage (labeled “Vref2”). An output of the amplifier 304 may be coupled to the gate of transistor Mc at the bias voltage (Vb) node, and a negative input of the amplifier 304 may be coupled to the Vc node (e.g., at the source of transistor Mc), thereby forming a local feedback loop in the gₘ-booster circuit 303.

The gₘ-booster circuit 303 may be utilized to effectively increase (i.e., “boost”) the gₘ of the transistor Mc, based on the gain (A) of the amplifier 304. For example, the gₘ of the transistor Mc may be boosted A times, where A=Vb/Vc. Boosting the effective gₘ of the transistor Mc may help to overcome the limited AC current generation capability and associated transient performance of the LDO regulator 300A. In this manner, a small change on the Vc node is amplified by the amplifier 304 for a larger variation on the Vb node, which is able to quickly generate a relatively large AC current through transistor Mc to charge or discharge the capacitance on the Vg node. With this fast-responding and large AC current, the gₘ-booster circuit 303 may reduce the voltage dip at the Vout node during a load attack.

The amplifier 304 may be low power (e.g., with sub-μA I_{Q}), because the amplifier 304 may drive the gate of transistor Mc (e.g., with a few fF capacitance), instead of driving the gate of transistor Mp, which may involve use of a power-hungry buffer (e.g., buffer 208), as described above. As described above, transistor Mc is smaller than transistor Mp, and thus, has lower capacitance. That is, the LDO regulator 300B with the gₘ-booster circuit 303 may achieve low I_{Q} and fast transient operation without using a buffer.

Due to the local feedback loop of the gₘ-booster circuit 303, the bias voltage determines the DC voltage of the Vc node. The bias voltage may be generated by a reference voltage source or by any of various other suitable circuits.

### Example Operations for Amplification and/or Voltage Regulation

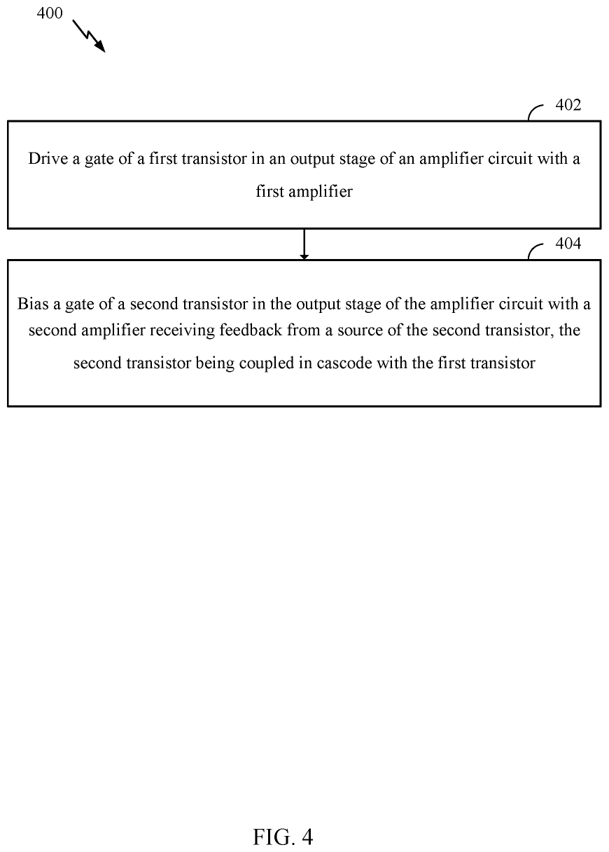

FIG. 4 is a flow diagram illustrating example operations 400 for amplification and/or voltage regulation, in accordance with certain aspects of the present disclosure. The operations 400 may be performed, for example, by a power supply circuit, such as the LDO regulator 300B of FIG. 3B, or by an amplifier circuit (e.g., an error amplifier) with a gₘ-booster circuit, such as the amplifier circuit 204 with the gₘ-booster circuit 303 of FIG. 3B.

The operations 400 may begin, at block 402, with a first amplifier (e.g., amplifier 301) driving a gate of a first transistor (e.g., transistor M1) in an output stage of the amplifier circuit (e.g., the output stage of FIG. 3B). At block 404, a second amplifier (e.g., amplifier 304) may bias a gate of a second transistor (e.g., transistor Mc) in the output stage of the amplifier circuit. The second amplifier may receive feedback from a source of the second transistor, and the second transistor may be coupled in cascode with the first transistor.

In certain aspects, the second amplifier may be configured to effectively boost a transconductance (gₘ) of the second transistor. In such cases, the boosted gₘ of the transistor may be based on a gain (e.g., gain A) of the second amplifier, as described above with respect to FIG. 3B.

In certain aspects, the second amplifier may have a quiescent current (I_{Q}) less than 1 μA.

According to certain aspects, the amplifier circuit may have an I_{Q} less than 1 μA.

In certain aspects, the operations 400 may further include driving a gate of a third transistor (e.g., transistor Mp) with the amplifier circuit. In this case, the first amplifier in the amplifier circuit may receive feedback from a voltage divider (e.g., voltage divider 214) coupled to a drain of the third transistor. The third transistor may be a power transistor of an LDO regulator.

### Example Aspects

In addition to the various aspects described above, specific combinations of aspects are within the scope of the disclosure, some of which are detailed below:

Aspect 1: A power supply circuit comprising: a first transistor having a source coupled to an input voltage (Vin) node and having a drain coupled to an output voltage (Vout) node; a second transistor having a drain coupled to a gate of the first transistor; a third transistor having a drain coupled to a source of the second transistor and having a source coupled to a reference potential node of the power supply circuit; a first amplifier having a first input coupled to a reference voltage node and having an output coupled to a gate of the third transistor, wherein a feedback path is coupled between the Vout node and a second input of the first amplifier; and a second amplifier having a first input coupled to a bias node, having a second input coupled to the source of the second transistor, and having an output coupled to a gate of the second transistor.

Aspect 2: The power supply circuit of Aspect 1, further comprising a capacitive element coupled between the source of the second transistor and the Vout node.

Aspect 3: The power supply circuit of Aspect 1 or 2, wherein the second amplifier has a quiescent current less than 1 μA.

Aspect 4: The power supply circuit of any of the preceding Aspects, wherein the second amplifier is configured to effectively boost a transconductance of the second transistor.

Aspect 5: The power supply circuit of Aspect 4, wherein the boosted transconductance is based on a gain of the second amplifier.

Aspect 6: The power supply circuit of any of the preceding Aspects, further comprising a current source coupled between the Vin node and the drain of the second transistor.

Aspect 7: The power supply circuit of any of the preceding Aspects, wherein no buffer is coupled between the drain of the second transistor and the gate of the first transistor.

Aspect 8: The power supply circuit of any of the preceding Aspects, wherein the power supply circuit is a low-dropout (LDO) regulator with a quiescent current less than 1 μA.

Aspect 9: The power supply circuit of any of the preceding Aspects, further comprising a voltage divider coupled between the Vout node and the reference potential node of the power supply circuit, wherein a tap of the voltage divider is coupled to the feedback path.

Aspect 10: An amplifier circuit comprising: an input stage; and an output stage having an input coupled to an output of the input stage, the output stage comprising: a transistor; and an amplifier having a first input coupled to a bias node, having a second input coupled to a source of the transistor, and having an output coupled to a gate of the transistor, the amplifier being configured to effectively boost a transconductance of the transistor.

Aspect 11: The amplifier circuit of Aspect 10, wherein the boosted transconductance of the transistor is based on a gain of the amplifier.

Aspect 12: The amplifier circuit of Aspect 10 or 11, wherein the amplifier has a quiescent current less than 1 μA.

Aspect 13: The amplifier circuit of any of Aspects 10-12, wherein the amplifier circuit has a quiescent current less than 1 μA.

Aspect 14: A method of amplification, comprising: driving a gate of a first transistor in an output stage of an amplifier circuit with a first amplifier; and biasing a gate of a second transistor in the output stage of the amplifier circuit with a second amplifier receiving feedback from a source of the second transistor, the second transistor being coupled in cascode with the first transistor.

Aspect 15: The method of Aspect 14, wherein the second amplifier is configured to effectively boost a transconductance of the second transistor.

Aspect 16: The method of Aspect 15, wherein the boosted transconductance of the second transistor is based on a gain of the second amplifier.

Aspect 17: The method of any of Aspects 14-16, wherein the second amplifier has a quiescent current less than 1 μA.

Aspect 18: The method of any of Aspects 14-17, wherein the amplifier circuit has a quiescent current less than 1 μA.

Aspect 19: The method of any of Aspects 14-18, further comprising driving a gate of a third transistor with the amplifier circuit, the first amplifier in the amplifier circuit receiving feedback from a voltage divider coupled to a drain of the third transistor.

Aspect 20: The method of Aspect 19, wherein the third transistor is a power transistor of a low-dropout (LDO) regulator.

Aspect 21: An apparatus, comprising means for performing a method in accordance with any one of Aspects 14-20.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or a processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a first transistor having a source coupled to an input voltage (Vin) node and having a drain coupled to an output voltage (Vout) node;
a second transistor having a drain coupled to a gate of the first transistor;
a third transistor having a drain coupled to a source of the second transistor and having a source coupled to a reference potential node of the power supply circuit;
a first amplifier having a first input coupled to a reference voltage node and having an output coupled to a gate of the third transistor, wherein a feedback path is coupled between the Vout node and a second input of the first amplifier; and
a second amplifier having a first input coupled to a bias node, having a second input coupled to the source of the second transistor, and having an output coupled to a gate of the second transistor.

2. The power supply circuit of claim 1, further comprising a capacitive element coupled between the source of the second transistor and the Vout node.

3. The power supply circuit of claim 1, wherein the second amplifier has a quiescent current less than 1 μA.

4. The power supply circuit of claim 1, wherein the second amplifier is configured to effectively boost a transconductance of the second transistor.

5. The power supply circuit of claim 4, wherein the boosted transconductance is based on a gain of the second amplifier.

6. The power supply circuit of claim 1, further comprising a current source coupled between the Vin node and the drain of the second transistor.

7. The power supply circuit of claim 1, wherein no buffer is coupled between the drain of the second transistor and the gate of the first transistor.

8. The power supply circuit of claim 1, wherein the power supply circuit is a low-dropout (LDO) regulator with a quiescent current less than 1 μA.

9. The power supply circuit of claim 1, further comprising a voltage divider coupled between the Vout node and the reference potential node of the power supply circuit, wherein a tap of the voltage divider is coupled to the feedback path.

10. An amplifier circuit comprising:
an input stage; and
an output stage having an input coupled to an output of the input stage, the output stage comprising:
a transistor; and
an amplifier having a first input coupled to a bias node, having a second input coupled to a source of the transistor, and having an output coupled to a gate of the transistor, the amplifier being configured to effectively boost a transconductance of the transistor.

11. The amplifier circuit of claim 10, wherein the boosted transconductance of the transistor is based on a gain of the amplifier.

12. The amplifier circuit of claim 10, wherein the amplifier has a quiescent current less than 1 μA.

13. The amplifier circuit of claim 10, wherein the amplifier circuit has a quiescent current less than 1 μA.

14. A method of amplification, comprising:
driving a gate of a first transistor in an output stage of an amplifier circuit with a first amplifier; and
biasing a gate of a second transistor in the output stage of the amplifier circuit with a second amplifier receiving feedback from a source of the second transistor, the second transistor being coupled in cascode with the first transistor.

15. The method of claim 14, wherein the second amplifier is configured to effectively boost a transconductance of the second transistor.

16. The method of claim 15, wherein the boosted transconductance of the second transistor is based on a gain of the second amplifier.

17. The method of claim 14, wherein the second amplifier has a quiescent current less than 1 μA.

18. The method of claim 14, wherein the amplifier circuit has a quiescent current less than 1 μA.

19. The method of claim 14, further comprising driving a gate of a third transistor with the amplifier circuit, the first amplifier in the amplifier circuit receiving feedback from a voltage divider coupled to a drain of the third transistor.

20. The method of claim 19, wherein the third transistor is a power transistor of a low-dropout (LDO) regulator.
